(19) United States
(12) Patent Application Publication
(10) Pub. No.: US 2008/0092760 A1
(43) Pub. Date: Apr. 24, 2008

(54) Device and Method for Driving a Reversing Gripper in a Sheet-Processing Machine, Reversing Drum and Printing Press

(75) Inventors: Karl-Heinz Helmstadter, Kaiserslautern (DE); Thomas Schmidt, Eppelheim (DE)

Correspondence Address: LERNER GREENBERG STEMER LLP, P O BOX 2480, HOLLYWOOD, FL, 33022-2480, US

(73) Assignee: HEIDELBERGER DRUCKMASCHINEN AG, Heidelberg (DE)

(21) Appl. No.: 11/867,359

(22) Filed: Oct. 4, 2007

(30) Foreign Application Priority Data
Oct. 19, 2006 (DE) DE102006049267.6

(51) Int. Cl. B41F 3/40; B41F 21/04

(52) U.S. Cl. 101/216; 101/246; 101/484

(57) ABSTRACT

A reversing gripper system of a sheet-processing machine includes respective drive motors for driving cooperating fixed grippers and spring-loaded grippers to create pivoting and opening movements. The motors may be stationary or may be disposed inside the periphery of a reversing drum. A transmission between a drive motor and the gripper system preferably includes a belt drive. A reversing drum, a printing press and a method of automated electronic adjustment of a gripper position and of gripper opening and closing times, are also provided.

### CROSS-REFERENCE TO RELATED APPLICATION

This application claims the priority, under 35 U.S.C. § 119, of German Patent Application DE 10 2006 049 267.6, filed Oct. 19, 2006; the prior application is herewith incorporated by reference in its entirety.

### BACKGROUND OF THE INVENTION

### Field of the Invention

The invention relates to a reversing gripper system disposed on a reversing drum in a sheet-processing machine, in particular a printing press. The invention also relates to a reversing drum with a gripper system, a printing press having the reversing drum and a method of automated adjustment of a gripper position.

The control of a pincer gripper of a reversing drum is mechanically complex and difficult to adjust. At high printing speeds, it is difficult to ensure that the grippers maintain an accurate motion sequence. That is true, in particular, for maintaining the gripper height and avoiding gripper rebounds. In addition to maintaining the actual motion sequence, the control unit must be convertible between straight-printing and perfecting, i.e. between one-sided and two-sided printing, depending on the mode of operation of the printing press. Usually, a converting device is required for that purpose. In difficult conditions due to high printing speeds, the clampings and converting mechanics of such a converting device are pushed to the limit.

Such a reversing gripper system is known, for example, from German Patent DE PS 24 14 998, corresponding to U.S. Pat. No. 4,101,122. The reversing gripper system described therein includes a number of pincer grippers. Each of the pincer grippers is formed of a fixed gripper and a spring-loaded gripper. In the straight-printing mode, the fixed gripper forms the gripper pad. In the perfecting mode, the fixed gripper finger is pivoted at the cycle of the sheet-processing machine under control of a cam follower. The spring-loaded gripper is likewise pivoted at the cycle of the machine through the use of a second cam follower control. During the reversing operation, the pivoting movements of the fixed gripper and the spring-loaded gripper are in phase, so that the gripper grips a sheet to be reversed or turned. The fixed gripper and the spring-loaded gripper are moved relative to each other in order to open and close the reversing gripper.

### SUMMARY OF THE INVENTION

It is accordingly an object of the invention to provide a device and a method for driving a reversing gripper in a sheet-processing machine, a reversing drum and a printing press, which overcome the hereinafore-mentioned disadvantages of the heretofore-known devices and methods of this general type and which provide an alternative drive for a reversing gripper system and a method of adjusting gripper positions.

With the foregoing and other objects in view there is provided, in accordance with the invention, a device for pivoting and opening a pincer gripper system of a sheet-transporting drum. The pincer gripper system is formed of a number of fixed grippers and a number of spring-loaded grippers cooperating with the fixed grippers. The device comprises a first drive motor for driving the fixed grippers and a second drive motor for driving the spring-loaded grippers. The drive motors are controlled (open-loop control) or regulated (closed-loop control) in mutual dependence on each other.

A particular advantage of the invention is that the pincer grippers of the reversing drum are driven by a drive device that is as simple as possible and easily adjustable. The dynamic behavior is improved and conversion from the straight-printing mode to the perfecting mode and vice versa is easy. Moreover, adaptation to print job parameters such as the speed and the thickness of the printing material, etc. is possible.

In an advantageous manner, two motors that are regulated (closed-loop control) in a mutually dependent way are used to drive the pincer gripper system. Each of the two drives controls the motion sequence of one of the two grippers forming the pincer gripper. The motor that controls the fixed gripper (gripper pad) is position-controlled, whereas the spring-loaded gripper (gripper finger) is position-controlled and force-controlled. In an advantageous manner, an electronic control unit is provided for making adjustments in terms of the mode of operation, printing speed, thickness of the printing material, etc. Forces are transmitted by a transmission gearing. The drive motors are fixed to the frame of the machine or disposed in the drum.

In a preferred embodiment, two motors are required. A respective one of them is fixed to the frame on the side wall of the drive side and the respective other one is fixed to the side wall of the operator side. The motors control the grippers' pivoting movement that is superimposed on the rotational movement. A gear transmission or a gear train is provided to transmit forces. An input of force to the respective gripper shaft and gripper tube, likewise occurs both on the drive side and on the operator side.

In particular, if a gear transmission is provided, the input of force may occur centrally by two additional shafts.

In an alternative embodiment, the motors for driving the gripper system are disposed in the reversing drum and rotate with the latter. In this case, the motors merely control the pivoting movement of the grippers, and the input of force preferably occurs centrally by toothed belts or timing belts. However, the input of force may also occur on the drive side and the operator side through gear transmission.

The motors are connected to a computer in which the predetermined paths of movement are stored, for the control (open-loop control) or regulating (closed-loop control) of the drive. There are sensors for providing appropriate data for controlling the drive in the computer. In particular, there are sensors for detecting the gripper position (height) of the fixed gripper forming the gripper pad and for measuring the force on the movable gripper as well as incremental encoders at the motors. As a result, the complex mechanical adjustment of the known gripper systems may be dispensed with because it is largely replaced by simple electronic adjustment.

With the objects of the invention in view, there is also provided a reversing drum, comprising a pincer gripper system, and a drive for the pincer gripper system according to the invention.

With the objects of the invention in view, there is additionally provided a sheet-fed rotary printing press, comprising a reversing drum having a pincer gripper system, and a drive for the pincer gripper system according to the invention.

With the objects of the invention in view, there is concomitantly provided a method of automated electronic adjustment of a gripper position and of gripper opening and closing times. The method comprises determining actual positions of fixed and spring-loaded grippers in a desired position, and then controlling motors driving the grippers until the grippers reach the desired position.

In the method of automatically setting the grippers to a desired position according to the invention, the motors are driven in an appropriate way until the grippers have reached the desired position.

Other features which are considered as characteristic for the invention are set forth in the appended claims.

Although the invention is illustrated and described herein as embodied in a device and a method for driving a reversing gripper in a sheet-processing machine, a reversing drum and a printing press, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, longitudinal-sectional view of a sheet-fed rotary printing press;

FIG. 2 is an enlarged, fragmentary, partly broken-away and partly sectional, front-elevational view of a gripper system driven by stationary drive motors;

FIG. 3 is a view similar to FIG. 2, showing the gripper system driven by drive motors disposed on a reversing drum; and

FIG. 4 is a cross-sectional view of the gripper system with stationary drive motors.

### DETAILED DESCRIPTION OF THE INVENTION

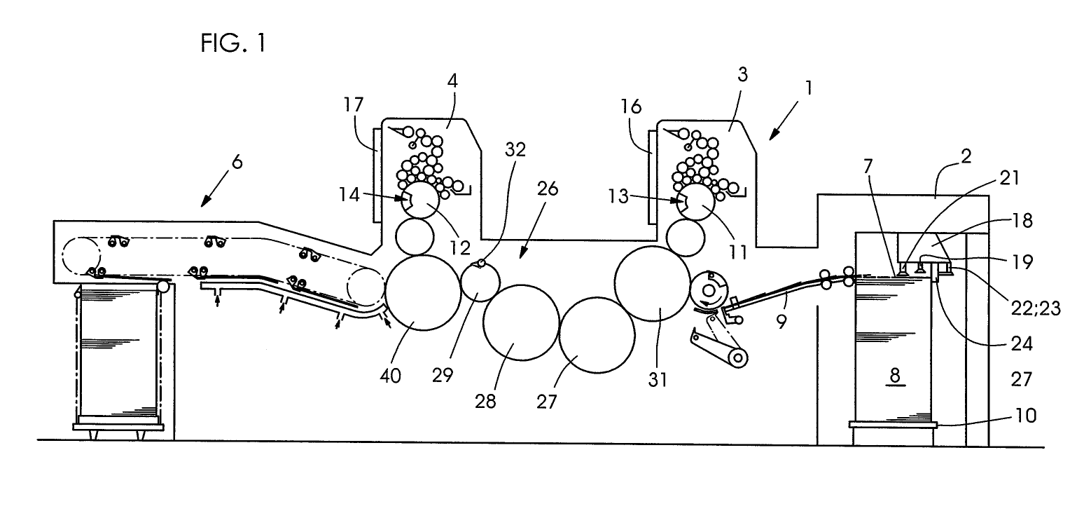

Referring now to the figures of the drawings in detail and first, particularly, to FIG. 1 thereof, there is seen a machine for processing sheets 7, for example a printing press 1, which includes a feeder 2, at least one printing unit 3, 4 and a delivery 6. The sheets 7 are taken from a sheet pile 8 and are fed to the printing units 3 and 4 over a feed table 9 as individual sheets or in a shingled stream. Each of the printing units 3, 4 includes a plate cylinder 11, 12, as is known in the art. Each of the plate cylinders 11 and 12 includes a device for fixing flexible printing plates. In addition, a device 16, 17 for semi-automatic or fully automatic plate changing is associated with each of the cylinders 11, 12.

The sheet pile 8 rests on a pile plate 10 that can be lifted in a controlled manner. The sheets 7 are removed from the top of the sheet pile 8 through the use of what is referred to as a suction head 18 which includes, among other elements, a number of lifting and dragging suckers 19, 21 for separating the sheets 7. Moreover, blower devices 22 for loosening the upper layers of sheets are provided as well as sensing elements 23 for initiating the lifting of the sheet pile. A number of lateral and trailing-edge stops 24 is provided to align the sheet pile 8, in particular the upper sheets 7, in the pile 8.

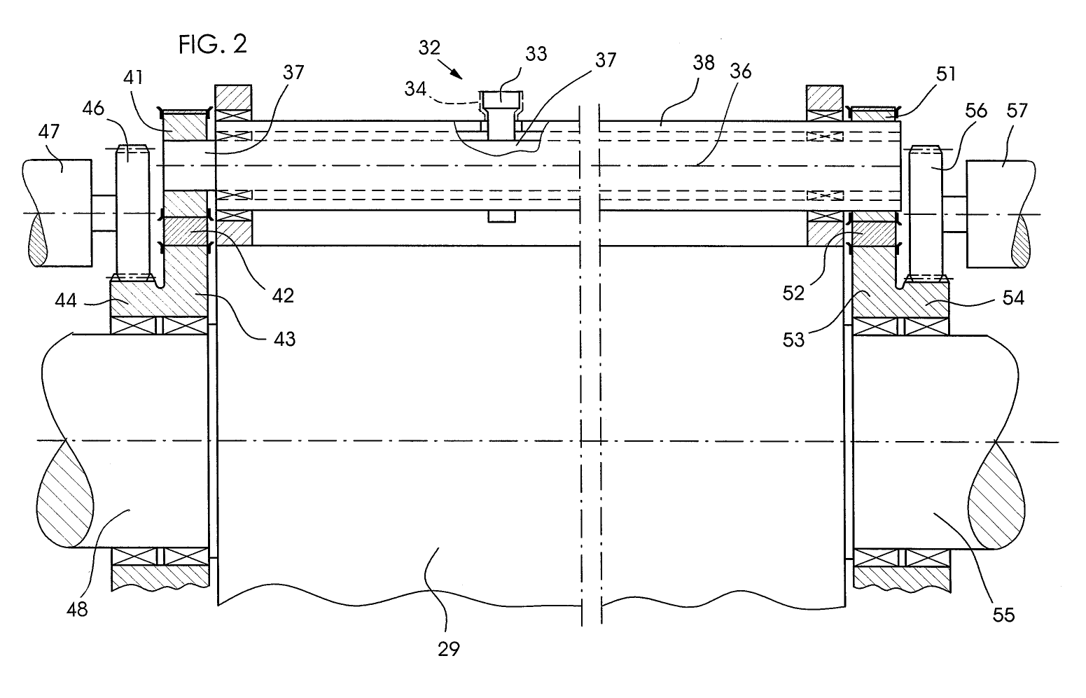

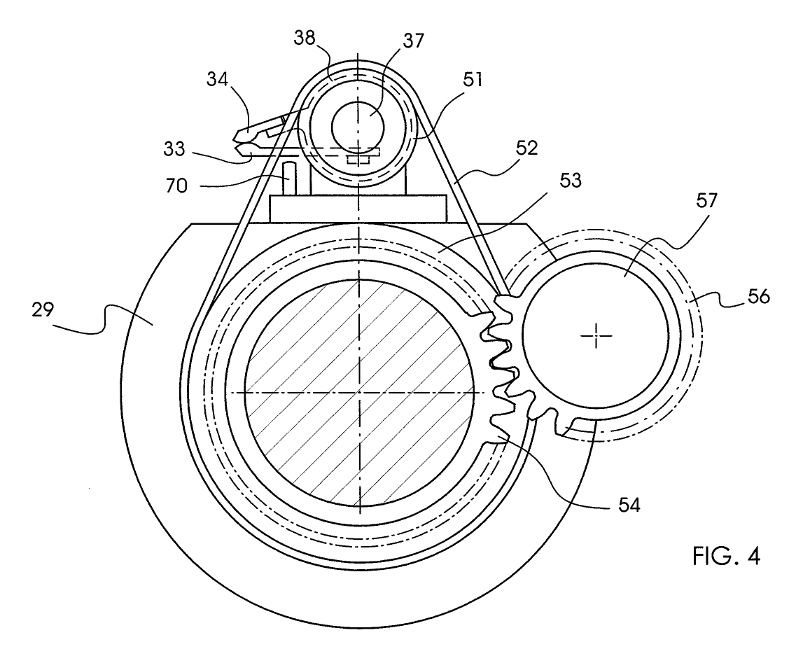

A three-drum reversing device 26 is provided between two impression cylinders 31 and 40. The three-drum reversing device 26 is formed of a transfer drum 27, a storage drum 28 and a reversing drum 29. The reversing drum 29 includes a pincer gripper system 32 for reversing the sheets in a perfecting mode, i.e. in a printing mode in which both sides of the sheets are printed in one pass as opposed to a straight-printing mode in which only one side of the sheets is being printed. Each of the remaining sheet-guiding cylinders includes gripper systems for transporting the sheets. As is seen in FIGS. 2, 3 and 4, the pincer or pliers-type gripper system 32 is formed of at least one fixed or rigid gripper 33, which forms a gripper pad, and a spring-loaded or spring-mounted gripper 34, which forms a gripper finger. In the perfecting mode, the grippers 33 and 34 are capable of being pivoted about a common axis 36. The grippers 33 are disposed on a gripper shaft 37 that is coaxially surrounded by a gripper tube 38. The grippers 34 are disposed on the gripper tube 38. The entire gripper system 32 is supported on the reversing drum 29 so as to be capable of being pivoted.

As is seen in FIG. 2, a pulley 41 is located on a first end of the gripper shaft 37. The pulley 41 is in drive connection with a pulley 43 through the use of a driving belt 42, preferably a toothed belt or timing belt. A gearwheel 44, that is driven by a pinion 46 of a stationary drive motor 47, is disposed parallel to the pulley 43.

The pulley 43 and the gearwheel 44 are jointly supported on a journal 48 of the reversing drum 29, so as to be capable of rotating.

A pulley 51 is located on a first end of the gripper tube 38. The pulley 51 is in drive connection with a pulley 53 through the use of a driving belt 52, preferably a toothed belt or timing belt. A gearwheel 54, which is driven by a pinion 56 of a stationary drive motor 57, is disposed parallel to the pulley 53. The pulley 53 and the gearwheel 54 are jointly supported on a journal 55 of the reversing drum 29.

The drive motors 47, 57 are driven in dependence on the speed of the reversing drum or the speed of the machine. In order to create a pivoting movement, i.e. a joint movement of the fixed gripper 33 and the spring-loaded gripper 34, the drive motors 47, 57 are driven in synchronism at a speed that is higher or lower than the speed of the reversing drum.

In order to create an opening or closing movement of the fixed gripper 33 and the spring-loaded gripper 34, the drive motor 57 is driven at a higher or lower speed than the reversing drum 29, while the drive motor 47 is driven at the same speed as the reversing drum 29.

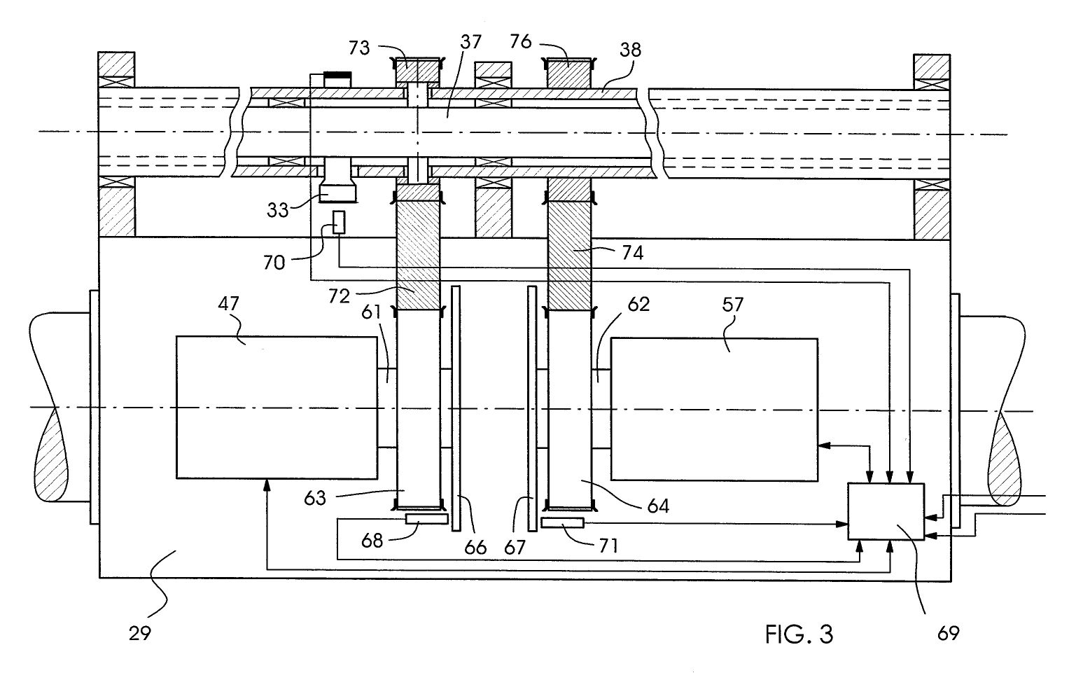

In a second exemplary embodiment, which is shown in FIG. 3, the drive motors 47, 57 are disposed on or in the reversing drum 29. In this case, they operate as simple servomotors, because they rotate together with the drum.

The drive motors 47, 57 are, for example, disposed inside the periphery of the reversing drum 29. Each of the drive motors 47, 57 includes a respective drive shaft 61, 62. Each of the drive shafts 61, 62 supports a respective pulley 63, 64 and a respective incremental disc 66, 67. The incremental disc 66 cooperates with a sensor 68 that is connected to a machine control unit 69. The incremental disc 67 cooperates with a sensor 71, which is likewise connected to the machine control unit 69.

The pulley 63 drives the gripper shaft 37 through the use of a timing belt 72 and a pulley 73. The pulley 73 is disposed approximately at the center of the gripper shaft 37.

The pulley 64 drives the gripper tube 38 through the use of a timing belt 74 and a pulley 76. The pulley 74 is likewise disposed approximately at the center of the gripper tube 38.

The drives 47, 57 are connected to the machine control unit 69, in which predetermined paths of movement and opening times for the gripper system 32 are stored, for the control (open-loop control) or regulating (closed-loop control) of the drives 47, 57. The sensor 68 indirectly detects the gripper position (gripper height) of the fixed gripper 33 in cooperation with the incremental disc 66. Alternatively, it is possible to directly detect the gripper position of the fixed gripper 33 through the use of a sensor 70.

The sensor 71 indirectly detects the gripper position of the spring-loaded gripper 34, in cooperation with the incremental disc 67.

Both of the motors 47 and 57 are position-controlled through the use of the machine control unit or computer 69. In addition, the motor 57 is force-controlled for the purpose of generating the appropriate predetermined holding forces.

The motors 47, 57 drive the grippers 33, 34 under the control of the machine control unit or computer 69 as defined by the respective predetermined path of movement for a selected mode of operation. In addition, optimized regulating (closed-loop control) takes place due to the data provided by the sensors. Both grippers 33, 34 are initially regulated (closed-loop control) in position. In the closing point, the gripper 33, which forms the gripper pad, is held in its position (height), while the gripper 34, which carries out the closing movement, pivots under force control until the required holding force is reached. The holding force may be predetermined depending on the subject to be processed or may be determined automatically.

A user interface of the machine control unit or computer 69 is used to select a different mode of operation, for example the perfecting mode. The motors 47, 57 are then controlled in a way that corresponds to the path of movement that is predetermined for this mode of operation. For the regulating (closed-loop control) through the sensors 68, 71, the computer prescribes new desired values in a corresponding way. No mechanical adjustments are required for this purpose.

The grippers 33, 34 are moved to their desired positions by motors for the electronic adjustment of the gripper control times at reference machine positions (gripper opening, gripper closing, transfer center). In a regulating (closed-loop control) operation, the actual position is corrected, and the association of gripper position and incremental encoder of the motor are stored. Due to such a correction of the actual position, a basic adjustment between motor 47, 57 and gripper 33, 34 for the predetermined path of movement is achieved. If required, the machine may automatically repeat such a calibration process at certain intervals, for example to compensate for a mispositioning of the grippers 33, 34 due to wear.

An additional recommendation is to provide collision protection for security purposes to prevent the gripper systems from pivoting or opening in the case of a failure of the servomotors or drive.

1. A device for pivoting and opening a pincer gripper system of a sheet-transporting drum, the pincer gripper system formed of a number of fixed grippers and a number of spring-loaded grippers cooperating with the fixed grippers, the device comprising:
a first drive motor for driving the fixed grippers; and
a second drive motor for driving the spring-loaded grippers;
said drive motors being controlled or regulated in mutual dependence on each other.

2. The device according to claim 1, wherein said drive motors are stationary, and said drive motors are each in drive connection with the gripper system through a respective transmission.

3. The device according to claim 1, wherein said drive motors are disposed inside a periphery of the sheet-transporting drum, and said drive motors are each in drive connection with the gripper system through a respective transmission.

4. The device according to claim 2, wherein said transmissions each include a belt drive.

5. The device according to claim 3, wherein said transmissions each include a belt drive.

6. The device according to claim 3, which further comprises a machine control unit driving said first drive motor in a position-controlled manner and driving said second drive motor in a position-controlled and a force-controlled manner.

7. The device according to claim 4, wherein said drive motors have incremental encoders, and sensors each determine a position of a respective one of said drive motors and cooperate with a respective one of said incremental encoders.

8. The device according to claim 5, wherein said drive motors have incremental encoders, and sensors each determine a position of a respective one of said drive motors and cooperate with a respective one of said incremental encoders.

9. A reversing drum, comprising a pincer gripper system, and a drive for said pincer gripper system according to claim 1.

10. A sheet-fed rotary printing press, comprising a reversing drum having a pincer gripper system, and a drive for said pincer gripper system according to claim 1.

11. A method of automated electronic adjustment of a gripper position and of gripper opening and closing times, the method comprising the following steps:
determining actual positions of fixed and spring-loaded grippers in a desired position; and
then controlling motors driving the grippers until the grippers reach the desired position.
